(19) United States
(12) Patent Application Publication
(10) Pub. No.: US 2023/0305520 A1
(43) Pub. Date: Sep. 28, 2023

(54) TOOL DIAGNOSTIC DEVICE AND TOOL DIAGNOSTIC METHOD

(71) Applicant: FANUC CORPORATION, Yamanashi (JP)

(72) Inventor: Yasuhiro SHIBASAKI, Yamanashi (JP)

(21) Appl. No.: 18/002,851

(22) PCT Filed: Jun. 21, 2021
(86) PCT No.: PCT/JP2021/023312

§ 371 Date: Dec. 21, 2022

(30) Foreign Application Priority Data
Jun. 24, 2020 (JP) 2020-109100

(51) Int. Cl. G05B 19/4065

(52) U.S. Cl. CPC G05B 19/4065; G05B 2219/37252; G05B 2219/37514

(57) ABSTRACT

A tool diagnostic device includes a data acquisition unit configured to acquire time-series data related to a deterioration state of a drilling tool when a hole is machined, a diagnostic section extraction unit configured to extract diagnostic section time-series data acquired when machining is performed in a diagnostic section from a middle position to a machining end position of the hole from the time-series data acquired by the data acquisition unit, and a deterioration diagnostic unit configured to diagnose deterioration of the drilling tool using the diagnostic section time-series data extracted by the diagnostic section extraction unit.

### TECHNICAL FIELD

The invention relates to a tool diagnostic device and a tool diagnostic method.

### BACKGROUND ART

Conventionally, in a machine tool, a usage limit of a machining tool is set for each specification of the machining tool. For example, as a usage limit of a drilling tool, a limit machining time, a limit machining distance, or a limit machining number recommended by a tool maker is used. A drilling tool reaching a usage limit is replaced with a new drilling tool.

However, in a method of setting the usage limit in this way, a usage condition under which the drilling tool is used, such as a machining condition or a material of a workpiece, is not taken into consideration. Therefore, there is concern that a drilling tool which has not deteriorated may be replaced with a new drilling tool, or even a severely deteriorating drilling tool may not be replaced.

Further, deterioration of the drilling tool is diagnosed by obtaining a rate of change of the disturbance load torque (Patent Document 1).

### CITATION LIST

### Patent Document

Patent Document 1: JP H7-51998 A

### SUMMARY OF THE INVENTION

### Problem to Be Solved by the Invention

However, in technology described in Patent Document 1, when detection data of the disturbance load torque is affected by noise, there is concern that deterioration of the drilling tool may not be diagnosed with high accuracy.

An object of the invention is to provide a tool diagnostic device and a tool diagnostic method for accurately diagnosing deterioration of the drilling tool.

### Means for Solving Problem

A tool diagnostic device includes a data acquisition unit configured to acquire time-series data related to a deterioration state of a drilling tool when a hole is machined, a diagnostic section extraction unit configured to extract diagnostic section time-series data acquired when machining is performed in a diagnostic section from a middle position to a machining end position of the hole from the time-series data acquired by the data acquisition unit, and a deterioration diagnostic unit configured to diagnose deterioration of the drilling tool using the diagnostic section time-series data extracted by the diagnostic section extraction unit.

A tool diagnostic method includes acquiring time-series data related to a deterioration state of a drilling tool when a hole is machined, extracting diagnostic section time-series data acquired when machining is performed in a diagnostic section from a middle position to a machining end position of the hole from the time-series data, and diagnosing deterioration of the drilling tool using the extracted diagnostic section time-series data.

### Effect of the Invention

According to the invention, it is possible to provide a tool diagnostic device and a tool diagnostic method for accurately diagnosing deterioration of a drilling tool.

### BRIEF DESCRIPTION OF DRAWINGS

FIG. 1 is a diagram for describing an example of a hardware configuration of a machine tool;

FIG. 2 is a block diagram illustrating an example of a function of a tool diagnostic device of a first embodiment;

FIG. 3 is a diagram illustrating an example of waveform data during machining of a hole using a new drilling tool;

FIG. 4 is a diagram illustrating an example of waveform data during machining of a hole using a non-new drilling tool;

FIG. 5 is a flowchart illustrating an example of processing executed by the tool diagnostic device of the first embodiment;

FIG. 6 is a block diagram illustrating an example of a function of a tool diagnostic device of a second embodiment;

FIG. 7 is a diagram illustrating an example of machining history data stored in a machining history storage unit;

FIG. 8 is a diagram illustrating an example of difference waveform data;

FIG. 9 is a flowchart illustrating an example of processing executed by the tool diagnostic device of the second embodiment;

FIG. 10 is a block diagram illustrating an example of a function of a tool diagnostic device of a third embodiment;

FIG. 11 is a diagram for describing a timing at which feature data is extracted and a remaining lifespan;

FIG. 12 is a flowchart illustrating an example of processing executed when a learning model is created; and

FIG. 13 is a flowchart illustrating an example of processing executed when a lifespan of a tool is diagnosed.

### MODE(S) FOR CARRYING OUT THE INVENTION

### First Embodiment

Hereinafter, a first embodiment will be described with reference to the drawings.

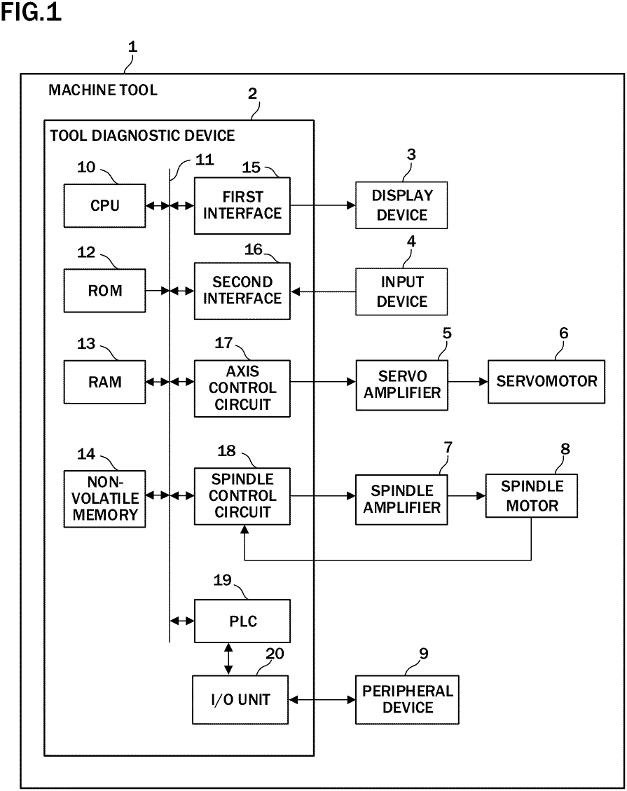

FIG. 1 is a diagram for describing an example of a hardware configuration of a machine tool.

The machine tool 1 includes a tool diagnostic device 2, a display device 3, an input device 4, a servo amplifier 5, a servomotor 6, a spindle amplifier 7, a spindle motor 8, and a peripheral device 9.

The tool diagnostic device 2 is a device for diagnosing deterioration such as wear of a tool, particularly a drilling tool. The drilling tool is, for example, a drill. The drill is, for example, a solid drill, a replaceable cutting edge drill, or a gun drill.

The tool diagnostic device 2 may be incorporated in a numerical controller of the machine tool 1. Further, the tool diagnostic device 2 may be incorporated in a PC (Personal Computer), a server, etc. connected to the numerical controller of the machine tool 1. In the present embodiment, the tool diagnostic device 2 is incorporated in the numerical controller of the machine tool 1, and the tool diagnostic device 2 will be described as executing each function of the numerical controller.

The tool diagnostic device 2 includes a CPU (Central Processing Unit) 10, a bus 11, a ROM (Read Only Memory) 12, a RAM (Random Access Memory) 13, and a non-volatile memory 14.

The CPU 10 is a processor that controls the entire tool diagnostic device 2 according to a system program. The CPU 10 reads a system program, a tool diagnostic program, etc. stored in the ROM 12 via the bus 11. Further, the CPU 10 executes a tool diagnostic process according to the tool diagnostic program. Further, the CPU 10 controls the servomotor 6 and the spindle motor 8, etc. according to a machining program, and executes drilling.

The bus 11 is a communication path that connects respective pieces of hardware in the tool diagnostic device 2 to each other. Each piece of hardware in the tool diagnostic device 2 exchanges data via the bus 11.

The ROM 12 is a storage device that stores a system program for controlling the entire tool diagnostic device 2, a tool diagnostic program for diagnosing deterioration of a drilling tool, an analysis program for analyzing various data, etc.

The RAM 13 is a storage device that temporarily stores various data. The RAM 13 temporarily stores data related to a tool path calculated by analyzing a machining program, data for display, data input from the outside, etc. The RAM 13 functions as a work area for the CPU 10 to process various data.

The non-volatile memory 14 is a storage device that holds data even when power of the machine tool 1 is turned off and power is not supplied to the tool diagnostic device 2. The non-volatile memory 14 includes, for example, an SSD (Solid State Drive). The non-volatile memory 14 stores, for example, tool correction data input from the input device 4, a machining program input via a network (not illustrated), etc.

The tool diagnostic device 2 further includes a first interface 15, a second interface 16, an axis control circuit 17, a spindle control circuit 18, a PLC (Programmable Logic Controller) 19, and an I/O unit 20.

The first interface 15 is an interface that connects the bus 11 and the display device 3 to each other. The first interface 15 transmits, for example, various data processed by the CPU 10 to the display device 3.

The display device 3 is a device that receives various data via the first interface 15 and displays the various data. The display device 3 displays, for example, a machining program stored in the non-volatile memory 14, data related to the tool correction amount, etc. The display device 3 is a display such as an LCD (Liquid Crystal Display).

The second interface 16 is an interface for connecting the bus 11 and the input device 4 to each other. The second interface 16 transmits, for example, data input from the input device 4 to the CPU 10 via the bus 11.

The input device 4 is a device for inputting various data. The input device 4 receives, for example, input of data related to the correction amount of the tool, and transmits the input data to the non-volatile memory 14 via the second interface 16. The input device 4 is, for example, a keyboard. Note that the input device 4 and the display device 3 may be configured as one device such as a touch panel.

The axis control circuit 17 is a control circuit that controls the servomotor 6. The axis control circuit 17 receives a control command from the CPU 10 and outputs a command for driving the servomotor 6 to the servo amplifier 5. The axis control circuit 17 transmits, for example, a torque command for controlling the torque of the servomotor 6 to the servo amplifier 5. Alternatively, the axis control circuit 17 may transmit a rotation speed command for controlling a rotation speed of the servomotor 6 to the servo amplifier 5.

The servo amplifier 5 receives a command from the axis control circuit 17 and supplies electric power to the servomotor 6.

The servomotor 6 is a motor driven by receiving electric power from the servo amplifier 5. The servomotor 6 is connected to, for example, a ball screw that drives a tool post, a spindle head, and a table. When the servomotor 6 is driven, components of the machine tool 1 such as the tool post, spindle head, and table move, for example, in an X-axis direction, a Y-axis direction, or a Z-axis direction. The machine tool 1 may have a detector (not illustrated) that detects a position and a moving speed of a component such as a tool post. In this case, the axis control circuit 17 may perform feedback control using detection data output from the detector.

The spindle control circuit 18 is a control circuit for controlling the spindle motor 8. When hole machining is performed based on a machining program, the spindle control circuit 18 receives a control command from the CPU 10 and outputs a command for driving the spindle motor 8 to the spindle amplifier. The spindle control circuit 18 transmits, for example, a torque command for controlling the torque of the spindle motor 8 to the spindle amplifier 7. Alternatively, the spindle control circuit 18 may transmit a rotation speed command for controlling a rotation speed of the spindle motor 8 to the spindle amplifier 7.

The spindle amplifier 7 receives a command from the spindle control circuit 18 and supplies electric power to the spindle motor 8.

The spindle motor 8 is a motor driven by receiving electric power from the spindle amplifier 7. The spindle motor 8 is connected to a spindle (not illustrated) to rotate the spindle.

The spindle motor 8 may be connected to, for example, a position coder (not illustrated) that detects a rotation angle of the spindle. The position coder outputs a feedback pulse according to the rotation angle of the spindle. The spindle control circuit 18 may perform feedback control using a feedback pulse output from the position coder. The feedback pulse input to the spindle control circuit 18 may be input to the CPU 10.

The PLC 19 is a controller that executes a ladder program to control the peripheral device 9. The PLC 19 controls the peripheral device 9 via the I/O unit 20.

The I/O unit 20 is an interface for connecting the PLC 19 and the peripheral device 9 to each other. The I/O unit 20 transmits a command received from the PLC 19 to the peripheral device 9.

The peripheral device 9 is a device installed in the machine tool 1 to perform an auxiliary operation when the machine tool 1 machines a workpiece. The peripheral device 9 may be a device installed around the machine tool 1. The peripheral device 9 is, for example, a tool changer or a robot such as a manipulator.

Next, a description will be given of a function of the tool diagnostic device 2 of the first embodiment.

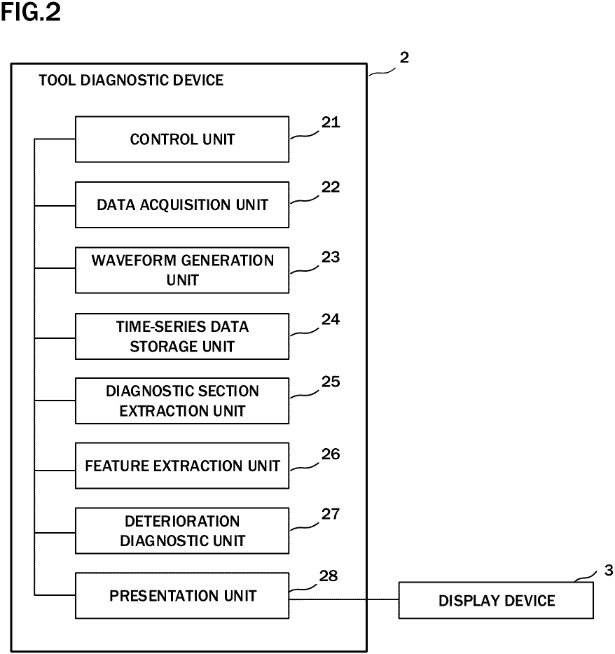

FIG. 2 is a block diagram illustrating an example of the function of the tool diagnostic device 2 of the first embodiment. The tool diagnostic device 2 includes, for example, a control unit 21, a data acquisition unit 22, a waveform generation unit 23, a time-series data storage unit 24, a diagnostic section extraction unit 25, a feature extraction unit 26, a deterioration diagnostic unit 27, and a presentation unit 28. For example, the control unit 21, the data acquisition unit 22, the waveform generation unit 23, the diagnostic section extraction unit 25, the feature extraction unit 26, the deterioration diagnostic unit 27, and the presentation unit 28 are realized by the CPU 10 performing arithmetic processing using the RAM 13 as a work area by using the system program, the tool diagnostic program, and various data stored in the ROM 12. Further, the time-series data storage unit 24 is realized by storing a calculation result of arithmetic processing of the CPU 10 in the RAM 13 or the non-volatile memory 14.

The control unit 21 controls the entire tool diagnostic device 2. For example, the control unit 21 controls the servomotor 6 and the spindle motor 8 according to a machining program to perform hole machining of a workpiece.

The data acquisition unit 22 acquires time-series data related to a deterioration state of the drilling tool when drilling is executed by the drilling tool. The deteriorated state refers to, for example, wear or breakage of the tool. The time-series data refers to a set of data acquired for each control cycle, for example, when hole machining is performed. The hole machined by the drilling tool is, for example, a blind hole.

For example, the data acquisition unit 22 acquires servo data as time-series data from the spindle control circuit 18.

The servo data is, for example, command data indicating a command value of a torque command output to the spindle amplifier 7 by the spindle control circuit 18, or feedback data indicating the torque of the spindle fed back from the spindle motor 8 to the spindle control circuit 18.

The servo data may be command data indicating a command value of a rotation speed command output to the spindle amplifier 7 by the spindle control circuit 18, or feedback data indicating a rotation speed of the spindle fed back from the spindle motor 8 to the spindle control circuit 18.

The waveform generation unit 23 generates waveform data based on time-series data acquired by the data acquisition unit 22. For example, the waveform generation unit 23 plots a command value of a torque command acquired for each control cycle on a graph in which a vertical axis indicates the command value of the torque command and a horizontal axis indicates time, and generates waveform data. That is, the waveform data is data processed so that a change in time-series data is perceived.

The waveform generation unit 23 generates waveform data based on time-series data acquired while first hole machining is performed using a new drilling tool. In addition, the waveform generation unit 23 generates waveform data based on time-series data acquired while hole machining is performed using a non-new drilling tool.

The new drilling tool is an unused drilling tool that has not been used for machining. The non-new drilling tool is a drilling tool that has been used to perform hole machining several times.

The waveform generation unit may generate waveform data at any timing. For example, waveform data may be continuously generated during machining of each hole. Alternatively, the waveform generation unit 23 may generate waveform data each time a predetermined number of holes are machined, or each time hole machining is performed for a predetermined time.

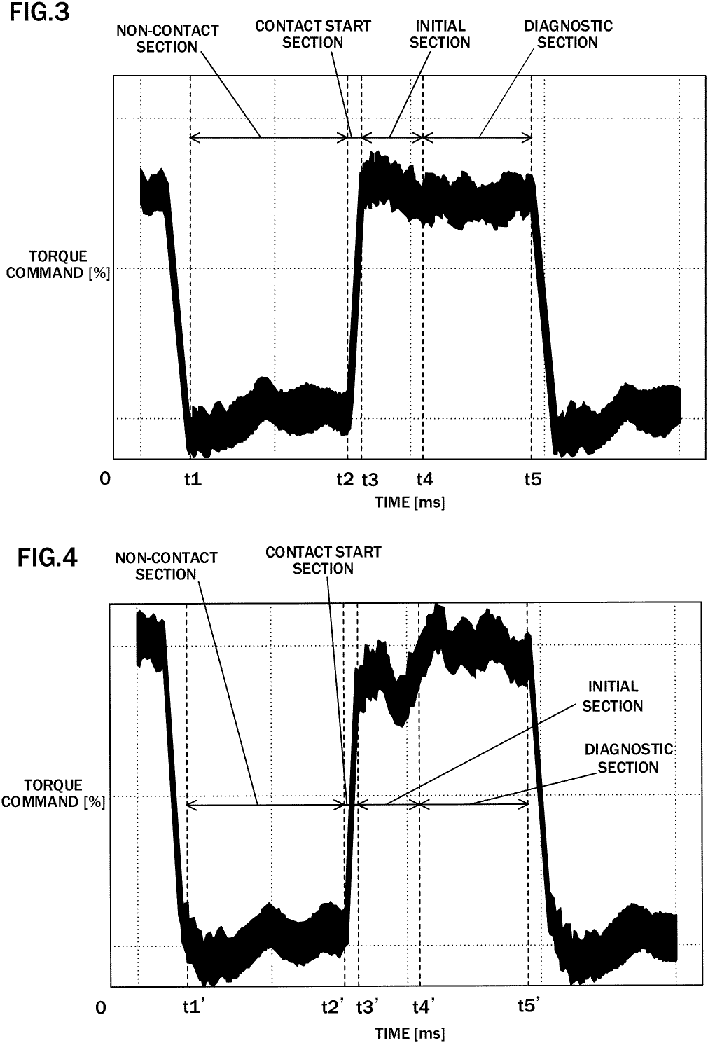

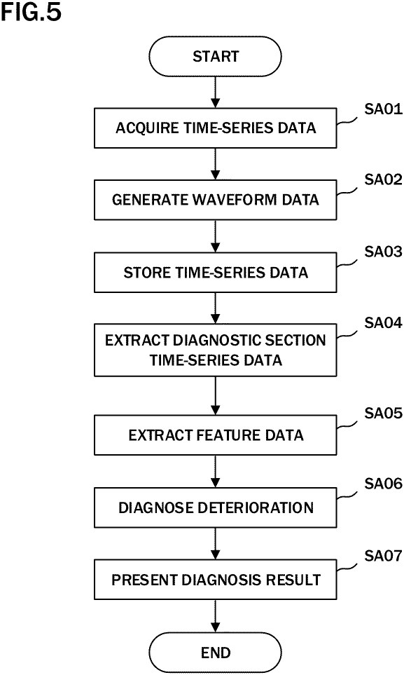

FIGS. 3 and 4 illustrate an example of waveform data generated by the waveform generation unit 23.

FIG. 3 is a diagram illustrating waveform data generated based on time-series data acquired when first hole machining is performed using a new drilling tool. In FIG. 3, the vertical axis indicates the command value of the torque command, and the horizontal axis indicates time.

Waveform data illustrated from t1 to t2 is generated based on time-series data acquired in a non-contact section in which the drilling tool and the workpiece are in a non-contact state. In the non-contact section, a data value of the waveform data is changing at a low value.

Waveform data illustrated from t2 to t3 is generated based on time-series data acquired in a contact start section in which contact between the drilling tool and the workpiece starts and the contact area between a cutting edge of the drilling tool and the workpiece increases. In the contact start section, a data value of the waveform data sharply rises.

Waveform data illustrated from t3 to t4 is generated based on time-series data acquired in an initial section in which machining is performed from a position where an outer circumference of the drilling tool comes into contact with the workpiece to a middle position of the hole. The middle position of the hole is a position between an entrance of the hole and a bottom of the hole after end of machining, and is a position on the entrance side of the middle of the hole. The middle position of the hole is, for example, a position at a depth of about ⅓ of a total length of the hole. That is, the initial section has a length equal to or less than that of a diagnostic section described later, and the diagnostic section has a length equal to or greater than that of the initial section. In the following, the position of the hole bottom after end of machining is referred to as a machining end position.

The initial section is a section in which a data value of the waveform data is not stable due to an influence of various noises. That is, it is difficult to reflect a deterioration state of the drilling tool in time-series data acquired in the initial section. In the initial section, the area of an outer peripheral surface of the drilling tool directed by an inner peripheral surface of the hole is small, and thus it is considered that vibration of the drilling tool is a cause.

In FIG. 3, in the initial section, the data value of the waveform data is slightly lowered as a whole. In other words, when the waveform data illustrated in FIG. 3 is smoothed, the data value of the time-series data slightly decreases in the initial section.

Waveform data illustrated from t4 to t5 is generated based on time-series data acquired in the diagnostic section from the middle position to the machining end position of the hole. The diagnostic section is a section in which time-series data reflecting the deterioration state of the drilling tool is acquired when the drilling tool deteriorates.

The data value of the waveform data in the diagnostic section illustrated in FIG. 3 remains at a substantially constant value on average. In other words, when the waveform data illustrated in FIG. 3 is smoothed, the data value of the waveform data remains at a substantially constant value in the diagnostic section.

t5 is a time when the drilling tool reaches the machining end position and drilling ends. At t5, drawing of the drilling tool from the hole is started. When the drilling tool is completely pulled out of the hole, the drilling tool is positioned in another hole to machine another hole.

FIG. 4 is a diagram illustrating waveform data generated based on time-series data acquired when machining is performed by a non-new drilling tool. In FIG. 4, a vertical axis indicates the command value of the torque command, and a horizontal axis indicates time. This waveform data is used to diagnose deterioration of the drilling tool.

Waveform data illustrated from t1′ to t2′ is generated based on time-series data acquired in a non-contact section. In the non-contact section, a data value of the waveform data remains at a low value.

Waveform data illustrated from t2′ to t3′ is generated based on time-series data acquired in a contact start section. Similar to the waveform data of the new drilling tool, the data value of the waveform data sharply rises in the contact start section.

Waveform data illustrated from t3′ to t4′ is generated based on time-series data acquired in an initial section. In the initial section, the data value of the waveform data moves up and down on average. In other words, when the waveform data illustrated in FIG. 4 is smoothed, the data value rises once, then falls, and then rises in the initial section. As described above, in the initial section, since the area of the outer peripheral surface of the drilling tool directed by the inner peripheral surface of the hole is small, it is considered that vibration of the drilling tool is a cause.

Waveform data illustrated from t4′ to t5′ is generated based on time-series data acquired in a diagnostic section. In the diagnostic section, the data value of the waveform data further rises on average and remains at a high value. In other words, when the waveform illustrated in FIG. 4 is smoothed, the data value rises in the diagnostic section and remains at a high value. A cause is that deterioration such as wear occurs on the cutting edge of the drilling tool and a cutting resistance increases.

t5′ is a time when the drilling tool reaches a machining end position and drilling ends. At t5′, drawing of the drilling tool is started. When the drilling tool is completely pulled out of the hole, the drilling tool is positioned in another hole to machine another hole.

Here, returning to FIG. 2, description of the tool diagnostic device 2 is continued.

The time-series data storage unit 24 stores time-series data acquired by the data acquisition unit 22. The time-series data stored in the time-series data storage unit 24 is, for example, waveform data generated by the waveform generation unit 23. The time-series data storage unit 24 stores time-series data acquired when machining is performed using a new drilling tool. Further, the time-series data storage unit 24 stores time-series data acquired when machining is performed using a non-new drilling tool.

The diagnostic section extraction unit 25 extracts diagnostic section time-series data acquired when machining of the diagnostic section is performed from time-series data stored in the time-series data storage unit 24. The diagnostic section time-series data is, for example, diagnostic section waveform data generated based on time-series data acquired when machining of the diagnostic section is performed.

The amount of diagnostic section time-series data to be extracted is set in advance by an operator, etc. according to a type of drilling tool or a combination of the type of drilling tool and a material of the workpiece. For example, when a diameter of the drilling tool is large with respect to a total length of the drilling tool, vibration generated at an initial stage of drilling is settled relatively early. In this case, a length of diagnostic section time-series data is set to be relatively long.

On the other hand, when the diameter is small with respect to the total length of the drilling tool, vibration does not settle until a certain length of a tip portion is directed by the inner peripheral surface of the hole. In this case, the length of the diagnostic section time-series data is set to be relatively short. A reason for setting the length of the diagnostic section time-series data in this way is to efficiently eliminate an influence of noise appearing in the time-series data in the initial section.

The diagnostic section extraction unit 25 extracts diagnostic section time-series data by specifying time-series data acquired when the drilling tool is performing machining in the diagnostic section, for example, based on a machining program and servo data.

The feature extraction unit 26 extracts feature data indicating a feature of diagnostic section time-series data extracted by the diagnostic section extraction unit 25. The feature data is, for example, at least one of an average, a variance, a degree of skew, and kurtosis of data values indicated by the diagnostic section time-series data. Further, the feature data may be a maximum value of the data values indicated by the diagnostic section time-series data.

The deterioration diagnostic unit 27 diagnoses deterioration of the drilling tool based on feature data extracted by the feature extraction unit 26. For example, the deterioration diagnostic unit 27 determines whether or not a data value indicated by the feature data is equal to or greater than a predetermined threshold value or equal to or less than the threshold value, and diagnoses whether or not the drilling tool deteriorates.

A plurality of threshold values may be set. In this case, the deterioration diagnostic unit 27 determines a threshold value exceeded by the feature data value, and diagnoses a degree of deterioration of the drilling tool.

For example, a first threshold value, a second threshold value, and a third threshold value are set. When the value of the feature data is less than the first threshold value, the deterioration diagnostic unit 27 determines that the drilling tool has not deteriorated. When the value of the feature data is equal to or greater than the first threshold value and less than the second threshold value, the deterioration diagnostic unit 27 determines that the degree of deterioration of the drilling tool is low. When the value of the feature data is equal to or greater than the second threshold value and less than the third threshold value, the deterioration diagnostic unit 27 determines that deterioration of the drilling tool has progressed a little. When the value of the feature data is equal to or greater than the third threshold value, the deterioration diagnostic unit 27 determines that deterioration of the drilling tool has progressed considerably and the usage limit has been reached.

The deterioration diagnostic unit 27 may estimate the lifespan of the drilling tool according to the degree of deterioration of the drilling tool. The lifespan of the drilling tool refers to a time until the drilling tool reaches the usage limit.

The presentation unit 28 presents a diagnosis result of the drilling tool by the deterioration diagnostic unit 27. For example, the presentation unit 28 outputs data indicating a diagnosis result of a deterioration state of the drilling tool to the display device 3. Further, the presentation unit 28 may output the feature data indicating the feature of the time-series data to the display device 3 together with the diagnosis result of the drilling tool.

Next, a description will be given of a flow of processing executed by the tool diagnostic device 2.

FIG. 5 is a flowchart illustrating an example of the flow of processing executed by the tool diagnostic device 2. The tool diagnostic device 2 may execute the processing described below each time each hole is machined. Alternatively, the tool diagnostic device 2 may execute this processing each time a predetermined number of holes are machined.

When hole machining is performed by the drilling tool, the data acquisition unit 22 acquires time-series data related to a deterioration state of the drilling tool (step SA01).

Next, the waveform generation unit 23 generates waveform data based on the time-series data acquired by the data acquisition unit 22 (step SA02).

Next, the time-series data storage unit 24 stores the time-series data acquired by the data acquisition unit 22 (step SA03). The time-series data stored in the time-series data storage unit 24 is, for example, waveform data generated by the waveform generation unit 23.

Next, the diagnostic section extraction unit 25 extracts diagnostic section time-series data from the time-series data stored in the time-series data storage unit 24 (step SA04).

Next, the feature extraction unit 26 extracts feature data indicating a feature of the diagnostic section time-series data extracted by the diagnostic section extraction unit 25 (step SA05).

Next, the deterioration diagnostic unit 27 diagnoses deterioration of the drilling tool based on the feature data extracted by the feature extraction unit 26 (step SA06) .

Next, the presentation unit 28 presents a diagnosis result of deterioration of the drilling tool diagnosed by the deterioration diagnostic unit 27 (step SA07), and ends the process.

The tool diagnostic device 2 of the present embodiment diagnoses deterioration of the drilling tool by using the diagnostic section time-series data. Therefore, an influence of noise appearing in the time-series data of the initial section may be eliminated. As a result, the tool diagnostic device 2 may accurately diagnose deterioration of the drilling tool.

Further, in the tool diagnostic device 2 of the present embodiment, the diagnostic section is set to have a length equal to or greater than that of the initial section from the entrance to the middle position of the hole. Therefore, deterioration of the drilling tool may be diagnosed based on time-series data in which the deterioration state of the drilling tool is reliably reflected.

Further, in the tool diagnostic device 2 of the present embodiment, time-series data of at least one of data indicating the torque of the spindle of the machine tool and data indicating a rotation speed of the spindle is acquired. Therefore, time-series data related to the deterioration state of the drilling tool may be easily acquired.

Further, in the tool diagnostic device 2 of the present embodiment, time-series data of at least one of command data for performing hole machining and feedback data fed back when hole machining is performed is acquired. Therefore, time-series data related to the deterioration state of the drilling tool may be easily acquired.

Further, in the present embodiment, feature data indicating the feature of the diagnostic section time-series data is extracted, and deterioration of the drilling tool is diagnosed based on the feature data. Therefore, an influence of noise may be eliminated to diagnose deterioration of the drilling tool.

Further, in the present embodiment, deterioration of the drilling tool is diagnosed based on at least one of features of an average, a variance, a degree of skew, and kurtosis of the data values indicated by the diagnostic section time-series data. Therefore, appropriate feature data may be used according to various drilling tools.

### Second Embodiment

Next, the second embodiment will be described with reference to the drawings. Note that description of the same configuration and function as those of the first embodiment will be omitted.

A tool diagnostic device of a second embodiment diagnoses deterioration of the drilling tool by using difference time-series data indicating a difference between reference time-series data serving as reference data and diagnosis time-series data serving as a diagnosis target in tool diagnosis. The reference time-series data and the diagnosis time-series data will be described in detail later.

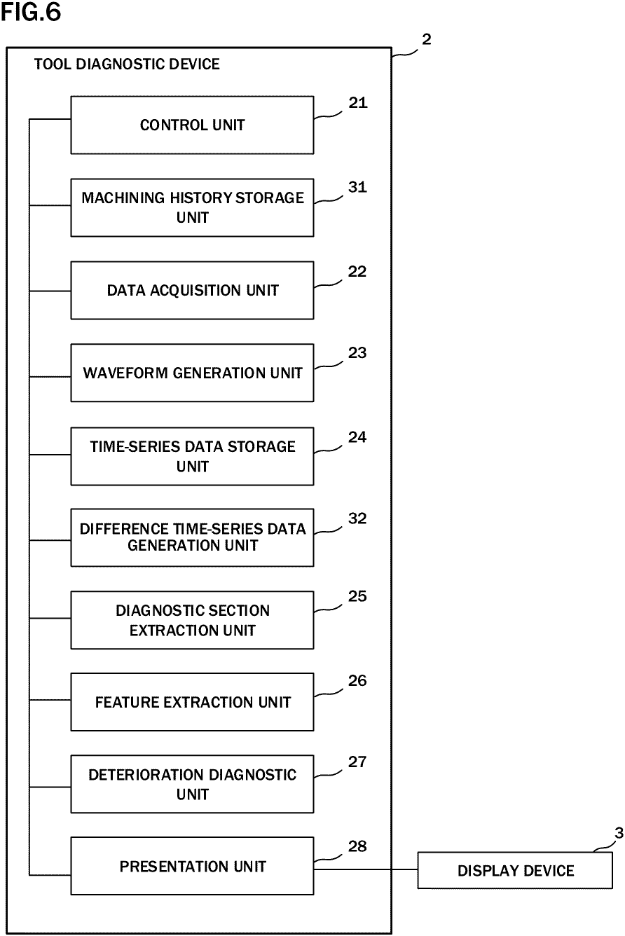

FIG. 6 is a block diagram illustrating an example of a function of the tool diagnostic device 2 of the second embodiment.

The tool diagnostic device 2 of the second embodiment includes the control unit 21, the data acquisition unit 22, the waveform generation unit 23, the time-series data storage unit 24, the diagnostic section extraction unit 25, the feature extraction unit 26, the deterioration diagnostic unit 27, and the presentation unit 28 included in the tool diagnostic device 2 of the first embodiment. In addition, the tool diagnostic device 2 further includes a machining history storage unit 31 and a difference time-series data generation unit 32.

The machining history storage unit 31 is realized, for example, by storing a calculation result of arithmetic processing of the CPU 10 in the RAM 13 or the non-volatile memory 14. Further, the difference time-series data generation unit 32 is realized by the CPU 10 performing arithmetic processing using the RAM 13 as a work area by using the system program, the tool diagnostic program, and various data stored in the ROM 12.

The machining history storage unit 31 stores machining history data related to a machining history of each drilling tool.

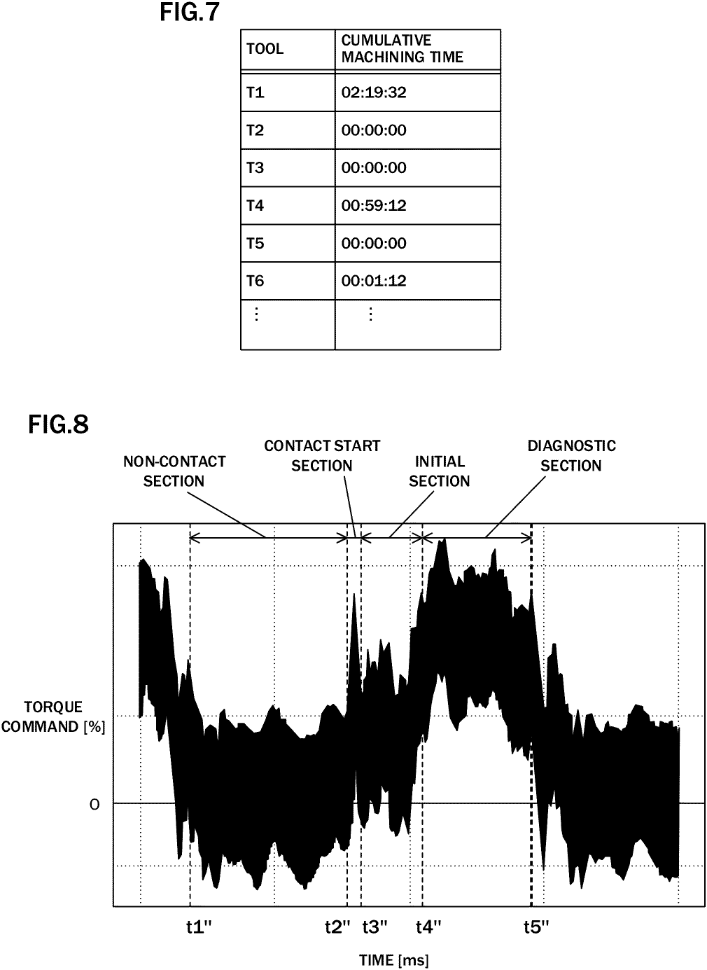

FIG. 7 is a diagram for describing machining history data stored in the machining history storage unit 31. The machining history storage unit 31 stores a cumulative machining time of each drilling tool when each hole is machined by the control unit 21. The cumulative machining time is, for example, a total cutting feed time when each drilling tool performs hole machining. Further, the machining history storage unit 31 may store the cumulative number of holes machined by each drilling tool.

The waveform generation unit 23 generates waveform data based on time-series data acquired by the data acquisition unit 22. The waveform generation unit 23 generates reference waveform data based on time-series data acquired while drilling is performed by a new drilling tool. The reference waveform data refers to waveform data serving as reference data when deterioration of the tool is diagnosed. As described in the first embodiment, the waveform data illustrated in FIG. 3 is waveform data generated based on time-series data acquired while drilling is performed by a new drilling tool. That is, the waveform data illustrated in FIG. 3 is reference waveform data.

The waveform generation unit 23 generates diagnostic waveform data based on time-series data acquired while drilling is performed by a non-new drilling tool. The diagnostic waveform data refers to waveform data to be diagnosed when diagnosing whether or not the drilling tool deteriorates. As described in the first embodiment, the waveform data illustrated in FIG. 4 is waveform data generated based on time-series data acquired while drilling is performed using a non-new drilling tool. That is, the waveform data illustrated in FIG. 4 is diagnostic waveform data.

For example, the waveform generation unit 23 refers to machining history data stored in the machining history storage unit 31, and determines whether waveform data to be generated is the reference waveform data or the diagnostic waveform data. For example, when the waveform generation unit 23 generates waveform data based on time-series data acquired when hole machining is performed by a drilling tool having a zero time as a cumulative machining time before hole machining, the generated waveform data is used as the reference waveform data. When the waveform generation unit 23 generates waveform data based on time-series data acquired when hole machining is performed by a drilling tool not having a zero time as a cumulative machining time before drilling, the generated waveform data is used as the diagnostic waveform data. The waveform generation unit 23 may attach, to the reference waveform data and the diagnostic waveform data, tags indicating that the reference waveform data and the diagnostic waveform data are the reference waveform data and the diagnostic waveform data, respectively.

The time-series data storage unit 24 stores reference time-series data acquired while drilling is performed using a new drilling tool. The reference time-series data stored in the time-series data storage unit 24 is, for example, reference waveform data generated by the waveform generation unit 23.

The time-series data storage unit 24 stores diagnostic time-series data acquired while drilling is performed using a non-new drilling tool. The diagnostic time-series data stored in the time-series data storage unit 24 is, for example, diagnostic waveform data generated by the waveform generation unit 23.

The difference time-series data generation unit 32 generates difference time-series data indicating a difference between the reference time-series data and the diagnostic time-series data stored in the time-series data storage unit 24. The difference time-series is, for example, difference waveform data indicating a difference between the reference waveform data and the diagnostic waveform data stored in the time-series data storage unit 24.

The difference time-series data generation unit 32 generates difference time-series data by calculating a difference between time-series data of each of a non-contact section, a contact start section, an initial section, and a diagnostic section in the diagnostic time-series data and time-series data of each of a non-contact section, a contact start section, an initial section, and a diagnostic section in the reference time-series data.

FIG. 8 is a diagram illustrating an example of difference waveform data. In FIG. 8, a vertical axis indicates the command value of the torque command, and a horizontal axis indicates time.

Difference waveform data indicating a difference between the reference waveform data and the diagnostic waveform data in the non-contact section is depicted from t1″ to t2″. The difference waveform data in the non-contact section remains around zero on average. That is, there is almost no difference between the reference waveform data and the diagnostic waveform data in this section.

Difference waveform data indicating a difference between the reference waveform data and the diagnostic waveform data in the contact start section is depicted from t2″ to t3″. In the contact start section, the difference waveform data temporarily increases. A reason therefor is considered that there is a momentary difference between a rise timing of a data value in the reference waveform data and a rise timing of a data value in the diagnostic waveform data.

Difference waveform data indicating a difference between the reference waveform data and the diagnostic waveform data in the initial section is depicted from t3″ to t4″. The difference waveform data in the initial section is higher than a value indicated by the difference waveform data in the non-contact section on average. A reason therefor is considered that there is a difference between noise appearing in the reference waveform data and noise appearing in the diagnostic waveform data in the initial section.

Difference waveform data indicating a difference between the reference waveform data and the diagnostic waveform data in the diagnostic section is depicted from t4″ to t5″. The difference waveform data in the diagnostic section remains at a high value on average. In other words, when the difference waveform data illustrated in FIG. 8 is smoothed, a value indicated by the difference waveform data remains at a high value in the diagnostic section. A reason therefor is that deterioration such as wear occurs on the cutting edge of the drilling tool and a cutting resistance increases.

t5″ is a time when the drilling tool reaches the machining end position and drilling ends. That is, t5″ is a time when the drilling tool reaches the machining end position. At t5″, drawing of the drilling tool is started.

Returning to FIG. 6, description of each unit of the tool diagnostic device 2 is continued.

The diagnostic section extraction unit 25 extracts diagnostic section time-series data acquired when machining is performed in the diagnostic section from the difference time-series data. For example, the diagnostic section extraction unit 25 extracts diagnostic section time-series data by specifying time-series data acquired when the drilling tool performs machining in the diagnostic section based on the machining program and the servo data.

The feature extraction unit 26 extracts feature data indicating a feature of the diagnostic section time-series data extracted by the diagnostic section extraction unit 25. The feature data is, for example, at least one of an average, a variance, a degree of skew, and kurtosis of data values indicated by the diagnostic section time-series data.

The deterioration diagnostic unit 27 diagnoses deterioration of the drilling tool based on feature data extracted by the feature extraction unit 26. For example, the deterioration diagnostic unit 27 determines whether or not a value indicated by the feature data is equal to or greater than a predetermined threshold value or equal to or less than the threshold value, and diagnoses whether or not the drilling tool deteriorates.

The presentation unit 28 presents a diagnosis result of the drilling tool by the deterioration diagnostic unit 27. For example, the presentation unit 28 outputs data indicating a diagnosis result of a deterioration state of the drilling tool to the display device 3.

Next, a description will be given of processing executed by the tool diagnostic device 2.

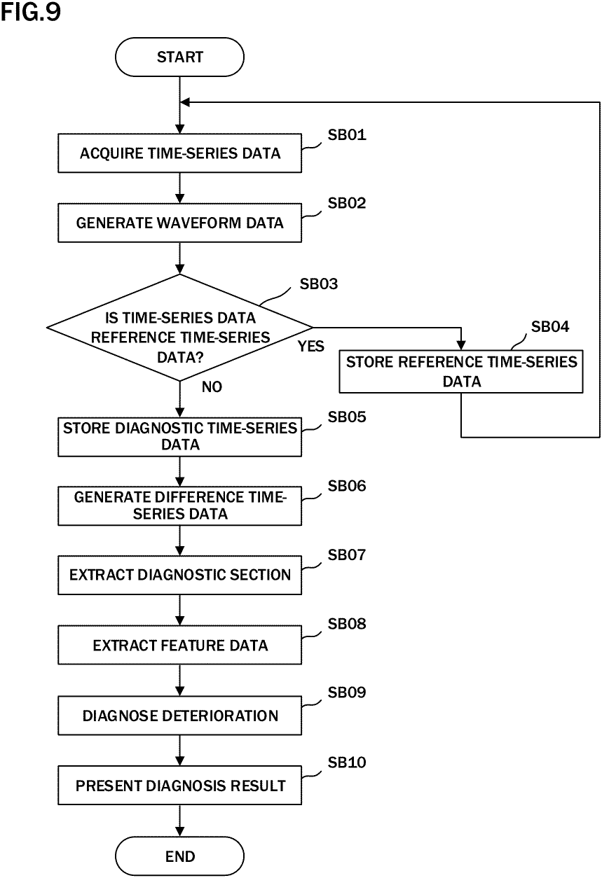

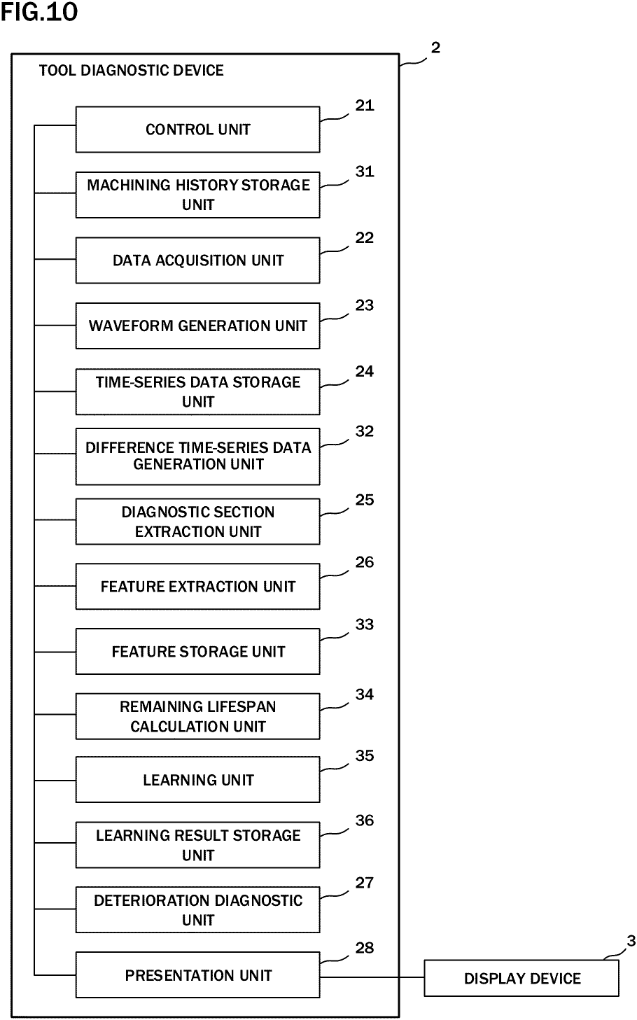

FIG. 9 is a flowchart illustrating an example of processing executed by the tool diagnostic device 2. The tool diagnostic device 2 may execute the processing described below each time each hole is machined. Alternatively, the tool diagnostic device 2 may execute this processing each time a predetermined number of holes are machined after fist machining is performed by a new drilling tool.

When hole machining is performed by the drilling tool, the data acquisition unit 22 acquires time-series data related to the deterioration state of the drilling tool (step SB01).

Next, the waveform generation unit 23 generates waveform data based on the time-series data acquired by the data acquisition unit 22 (step SB02).

Next, it is determined whether the acquired time-series data is reference time-series data or diagnostic time-series data (step SB03).

When the acquired time-series data is the reference time-series data (Yes in step SB03), the time-series data storage unit 24 stores the reference time-series data (step SB04). When the time-series data storage unit 24 stores the reference time-series data, the process returns to step SB01 again.

When the acquired time-series data is the diagnostic time-series data (No in step SB03), the time-series data storage unit 24 stores the diagnostic time-series data (step SB05).

Next, the difference time-series data generation unit 32 generates difference time-series data based on the reference time-series data and the diagnostic time-series data stored in the time-series data storage unit 24 (step SB06) .

Next, the diagnostic section extraction unit 25 extracts diagnostic section time-series data indicating time-series data acquired while machining is performed in the diagnostic section from the difference time-series data generated by the difference time-series data generation unit 32 (step SB07).

Next, the feature extraction unit 26 extracts feature data indicating a feature of the diagnostic section time-series data (step SB08).

Next, the deterioration diagnostic unit 27 diagnoses deterioration of the drilling tool based on the feature data extracted by the feature extraction unit 26 (step SB09) .

Finally, the presentation unit 28 presents a diagnosis result of the drilling tool diagnosed by the deterioration diagnostic unit 27 (step SB10).

The tool diagnostic device 2 of the present embodiment diagnoses deterioration of the drilling tool based on the difference time-series data indicating the difference between the reference time-series data and the diagnostic time-series data. Therefore, it is unnecessary to set a threshold value serving as a reference value for determining that the drilling tool has deteriorated for each drilling tool. That is, deterioration of the drilling tool may be easily diagnosed.

### Third Embodiment

Next, a tool diagnostic device 2 of a third embodiment will be described. Note that description of the same configuration and function as those of the tool diagnostic device 2 of the first embodiment or the second embodiment will be omitted.

The tool diagnostic device 2 of the third embodiment has a configuration for diagnosing the lifespan of the drilling tool using machine learning.

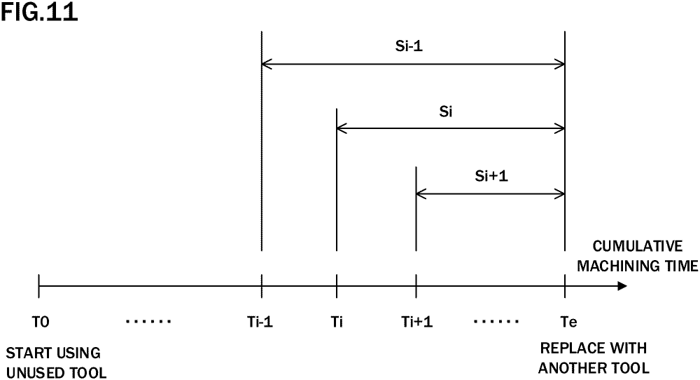

FIG. 10 is a block diagram illustrating an example of the function of the tool diagnostic device 2 of the third embodiment.

The tool diagnostic device 2 of the third embodiment includes the control unit 21, the machining history storage unit 31, the data acquisition unit 22, the waveform generation unit 23, the time-series data storage unit 24, the difference time-series data generation unit 32, the diagnostic section extraction unit 25, the feature extraction unit 26, the deterioration diagnostic unit 27, and the presentation unit 28 included in the tool diagnostic device 2 of the second embodiment. In addition, the tool diagnostic device 2 further includes a feature storage unit 33, a remaining lifespan calculation unit 34, a learning unit 35, and a learning result storage unit 36.

The feature storage unit 33 and the learning result storage unit 36 are realized, for example, by storing a calculation result of arithmetic processing of the CPU 10 in the RAM 13 or the non-volatile memory 14. Further, the remaining lifespan calculation unit 34 and the learning unit 35 are realized by, for example, the CPU 10 performing arithmetic processing using the RAM 13 as a work area by using the system program, the tool diagnostic program, and various data stored in the ROM 12.

Until the new drilling tool reaches a usage limit, the feature storage unit 33 sequentially stores each piece of feature data indicating a feature of the generated difference time-series data. The feature storage unit 33 stores each piece of feature data indicating a feature of the difference time-series data in association with a cumulative machining time of the drilling tool when diagnostic time-series data, which is original data of the difference time-series data, is acquired.

When the drilling tool reaches the usage limit, the remaining lifespan calculation unit 34 calculates a remaining lifespan at a timing when each piece of feature data is extracted, based on the timing when the drilling tool reaches the usage limit and the timing when each piece of feature data is extracted. Here, the timing at which the feature data is extracted refers to the same timing as the timing at which the diagnostic time-series data, which is the original data of the difference time-series data, is acquired.

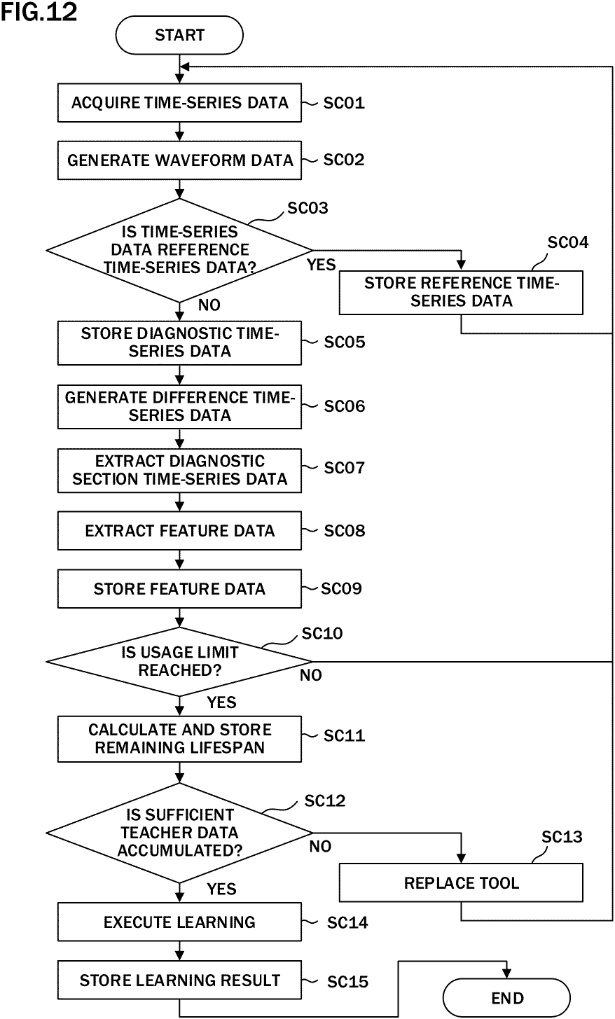

FIG. 11 is a diagram illustrating a relationship between a timing Ti at which feature data is extracted and a remaining lifespan Si. The remaining lifespan calculation unit 34 subtracts a cumulative machining time of the drilling tool at the timing Ti at which each piece of feature data is extracted from a cumulative machining time when the drilling tool reaches the usage limit, and calculates the remaining lifespan Si at the timing Ti at which each piece of feature data is extracted.

The feature storage unit 33 stores feature data extracted at each timing Ti in association with data indicating the remaining lifespan Si.

The learning unit 35 performs machine learning using a data set including input data and output data. The learning unit performs machine learning using feature data stored in the feature storage unit 33 as input data and data indicating the remaining lifespan Si as output data. For example, the learning unit 35 performs supervised learning using the data set including the input data and the output data as teacher data. For supervised learning, for example, a neural network and an SVM (Support Vector Machine) may be used.

The learning unit 35 learns a correlation between the feature data and the remaining lifespan Si in machine learning. As a result of learning, the learning unit 35 generates a learning model indicating the correlation between the feature data and the remaining lifespan Si.

The learning result storage unit 36 stores the learning model generated by the learning unit 35 executing machine learning.

The deterioration diagnostic unit 27 diagnoses the remaining lifespan Si of the tool by using the learning model stored in the learning result storage unit 36. The deterioration diagnostic unit 27 inputs feature data indicating a feature of the diagnostic section time-series data to the learning model, and obtains an output related to the remaining lifespan Si of the drilling tool. As a result, the deterioration diagnostic unit 27 may diagnose the remaining lifespan Si when the diagnostic time-series data, which is the original data of the difference time-series data, is acquired.

The presentation unit 28 presents a diagnosis result of the drilling tool executed by the deterioration diagnostic unit 27. For example, the presentation unit 28 outputs the diagnosis result to the display device 3.

Next, a description will be given of processing when the tool diagnostic device 2 creates a learning model.

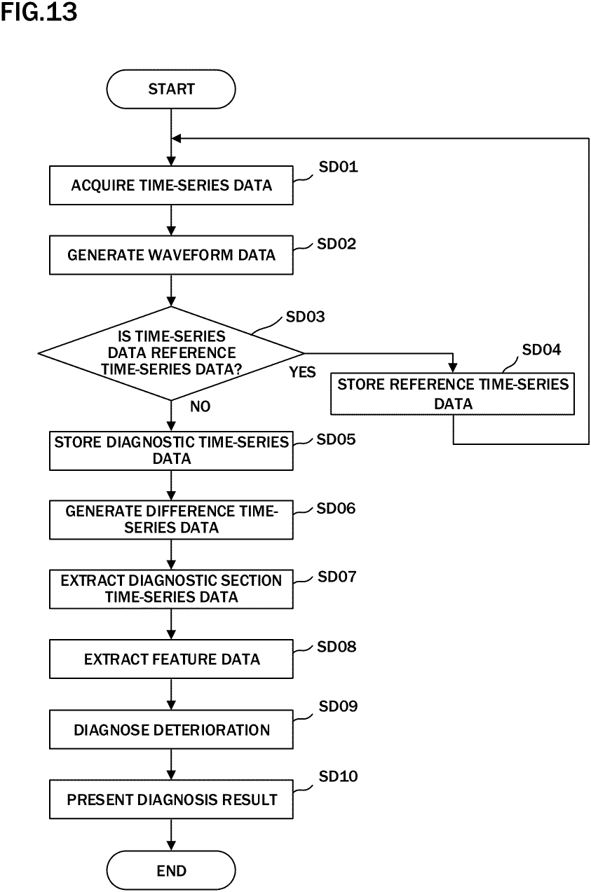

FIG. 12 is a flowchart illustrating an example of processing executed when the tool diagnostic device 2 creates a learning model. The tool diagnostic device 2 may execute processing described below each time each hole is machined. Alternatively, the tool diagnostic device 2 may execute this processing each time a predetermined number of holes are machined after first machining is performed by a new drilling tool.

When the drilling is performed by the drilling tool, the data acquisition unit 22 acquires time-series data related to the deterioration state of the drilling tool (step SC01).

Next, the waveform generation unit 23 generates waveform data indicating the time-series data acquired by the data acquisition unit 22 (step SC02).

Next, it is determined whether the acquired time-series data is reference time-series data or diagnostic time-series data (step SC03).

When the acquired time-series data is the reference time-series data (Yes in step SC03), the time-series data storage unit 24 stores the reference time-series data (step SC04). When the time-series data storage unit 24 stores the reference time-series data, the process returns to step SC01 again.

When the acquired time-series data is the diagnostic time-series data (No in step SC03), the time-series data storage unit 24 stores the diagnostic time-series data (step SC05).

Next, the difference time-series data generation unit 32 generates difference time-series data based on the reference time-series data and the diagnostic time-series data stored in the time-series data storage unit 24 (step SC06).

Next, the diagnostic section extraction unit 25 extracts diagnostic section time-series data indicating time-series data acquired while machining is performed in the diagnostic section from the difference time-series data generated by the difference time-series data generation unit 32 (step SC07).

Next, the feature extraction unit 26 extracts feature data indicating a feature of the diagnostic section time-series data extracted by the diagnostic section extraction unit 25 (step SC08).

Next, the feature storage unit 33 stores the feature data extracted by the feature extraction unit 26 (step SC09).

Next, it is determined whether or not the drilling tool has reached the usage limit (step SC10). For example, when the drilling tool is broken, or when surface roughness of a machined hole exceeds a predetermined threshold value, it is determined to be the usage limit. The usage limit may be determined by a skilled operator.

When it is determined that the drilling tool has not reached the usage limit (No in step SC10), the process returns to step SC01 again.

When it is determined that the drilling tool has reached the usage limit (Yes in step SC10), the remaining lifespan calculation unit 34 calculates the remaining lifespan Si at the timing Ti at which each piece of feature data stored in the feature storage unit 33 is extracted, and causes the feature storage unit 33 to store the feature data in association with data indicating the remaining lifespan Si (step SC11).

Next, it is determined whether or not sufficient teacher data is accumulated in the feature storage unit 33 (step SC12). The teacher data stored in the feature storage unit 33 refers to a data set of the feature data and the data indicating the remaining lifespan Si associated with the feature data. The determination is performed depending on whether or not the amount of data in the data set stored in the feature storage unit 33 has reached a predetermined amount of data.

When it is determined that sufficient teacher data has not been accumulated (No in step SC12), the drilling tool is replaced with a new drilling tool (step SC13), and the process returns to step SC01.

When it is determined that sufficient teacher data has been accumulated (Yes in step SC12), the learning unit 35 executes learning and creates a learning model (step SC14).

Next, the learning result storage unit 36 stores the learning model created by the learning unit 35 (step SC15).

The tool diagnostic device 2 creates a learning model by executing the above processing.

Next, a description will be given of an example of processing executed by the tool diagnostic device 2 when diagnosing the lifespan of the tool using a learning model.

FIG. 13 is a flowchart illustrating an example of processing executed by the tool diagnostic device 2 when the lifespan of the drilling tool is diagnosed. The tool diagnostic device 2 may execute processing described below each time each hole is machined. Further, the tool diagnostic device 2 may execute this processing each time a predetermined number of holes are machined.

When the drilling is performed by the drilling tool, the data acquisition unit 22 acquires time-series data related to the deterioration state of the drilling tool (step SD01).

Next, the waveform generation unit 23 generates waveform data indicated by the time-series data acquired by the data acquisition unit 22 (step SD02) .

Next, it is determined whether the acquired time-series data is the reference time-series data or the diagnostic time-series data (step SD03).

When the acquired time-series data is the reference time-series data (Yes in step SD03), the time-series data storage unit 24 stores the reference time-series data (step SC04). When the time-series data storage unit 24 stores the reference time-series data, the process returns to step SD01 again.

When the acquired time-series data is the diagnostic time-series data (No in step SD03), the time-series data storage unit 24 stores the diagnostic time-series data (step SD05).

Next, the difference time-series data generation unit 32 generates difference time-series data based on the reference time-series data and the diagnostic time-series data stored in the time-series data storage unit 24 (step SD06) .

Next, the diagnostic section extraction unit 25 extracts diagnostic section time-series data indicating the time-series data acquired while machining is performed in the diagnostic section from the difference time-series data generated by the difference time-series data generation unit 32 (step SD07).

Next, the feature extraction unit 26 extracts feature data indicating the feature of the diagnostic section time-series data extracted by the diagnostic section extraction unit 25 (step SD08).

Next, the deterioration diagnostic unit 27 inputs the feature data to the learning model stored in the learning result storage unit 36, and diagnoses the remaining lifespan Si of the tool (step SD09).

Next, the presentation unit 28 presents the remaining lifespan Si of the drilling tool diagnosed by the deterioration diagnostic unit 27 (step SD10).

The tool diagnostic device 2 may diagnose the remaining lifespan Si of the tool by executing the above processing.

The tool diagnostic device 2 of the present embodiment may diagnose the remaining lifespan Si of the drilling tool with high accuracy by diagnosing the remaining lifespan Si of the tool using the learning model created by the learning unit 35 executing machine learning.

Even though the first to third embodiments of the invention have been described above, the invention is not limited to the only examples of the above-described embodiments, and may be implemented in various aspects by making appropriate changes.

For example, the data acquisition unit 22 may acquire time-series data related to the deterioration state of the drilling tool from a plurality of machine tools 1 connected via a network (not illustrated). In this case, a large amount of teacher data may be accumulated in the feature storage unit 33 in a short time. In addition, the deterioration diagnostic unit 27 may diagnose deterioration of the drilling tool used in each of the plurality of machine tools.

Further, the tool diagnostic device 2 may perform deterioration diagnosis of the drilling tool using a learning model created by another tool diagnostic device 2 connected via the network. In this case, the tool diagnostic device 2 does not need to execute machine learning to create a learning model.

Further, in the above-described embodiment, at least one of the torque of the spindle and the rotation speed of the spindle of the machine tool 1 is used as the servo data. However, the servo data is not limited thereto, and may be, for example, feedback data of a current value of a current supplied to the servomotor 6 or a current value acquired from the servomotor 6.

Further, the time-series data acquired by the data acquisition unit 22 is not limited to the servo data. For example, it is possible to acquire time-series data related to vibration generated in the drilling tool when drilling is performed using an acceleration sensor, etc. Alternatively, it is possible to acquire time-series data related to elastic waves emitted from the drilling tool using an AE (Acoustic Emission) sensor. In these cases, deterioration of the drilling tool may be diagnosed by performing frequency analysis of time-series data acquired in the diagnostic section.

Further, in the embodiments described above, it is unnecessary to plot time-series data on a graph. That is, the tool diagnostic device 2 may extract feature data indicating a feature of time-series data by executing arithmetic processing of diagnostic section time-series data acquired in the diagnostic section from the time-series data, and diagnose deterioration of the drilling tool based on the feature data.

In addition, when the deterioration diagnostic unit 27 determines that the drilling tool has reached the usage limit, the control unit 21 may transmit, to a tool changer, a command for replacing the drilling tool reaching the usage limit with a spare drilling tool.

Further, in the third embodiment, a description has been given of an example in which learning is performed using the difference time-series data. However, it is not necessary to use the difference time-series data. That is, the learning unit 35 may generate a learning model by learning a correlation between feature data indicating the feature of the diagnostic section of the diagnostic time-series data and the remaining lifespan when the diagnostic time-series data is acquired.

EXPLANATIONS OF LETTERS OR NUMERALS

| | |
|---|---|
| 1 | MACHINE TOOL |
| 2 | TOOL DIAGNOSTIC DEVICE |
| 3 | DISPLAY DEVICE |
| 4 | INPUT DEVICE |
| 5 | SERVO AMPLIFIER |
| 6 | SERVOMOTOR |
| 7 | SPINDLE AMPLIFIER |
| 8 | SPINDLE MOTOR |
| 9 | PERIPHERAL DEVICE |
| 10 | CPU |
| 11 | BUS |
| 12 | ROM |
| 13 | RAM |
| 14 | NON-VOLATILE MEMORY |
| 15 | FIRST INTERFACE |
| 16 | SECOND INTERFACE |
| 17 | AXIS CONTROL CIRCUIT |
| 18 | SPINDLE CONTROL CIRCUIT |
| 19 | PLC |
| 20 | I/O UNIT |
| 21 | CONTROL UNIT |
| 22 | DATA ACQUISITION UNIT |
| 23 | WAVEFORM GENERATION UNIT |
| 24 | TIME-SERIES DATA STORAGE UNIT |
| 25 | DIAGNOSTIC SECTION EXTRACTION UNIT |
| 26 | FEATURE EXTRACTION UNIT |
| 27 | DETERIORATION DIAGNOSTIC UNIT |
| 28 | PRESENTATION UNIT |
| 31 | MACHINING HISTORY STORAGE UNIT |
| 32 | DIFFERENCE TIME-SERIES DATA GENERATION UNIT |
| 33 | FEATURE STORAGE UNIT |
| 34 | REMAINING LIFESPAN CALCULATION UNIT |
| 35 | LEARNING UNIT |
| 36 | LEARNING RESULT STORAGE UNIT |
| Ti | TIMING |
| Si | REMAINING LIFESPAN |

1. A tool diagnostic device comprising:
a data acquisition unit configured to acquire time-series data related to a deterioration state of a drilling tool when a hole is machined;
a diagnostic section extraction unit configured to extract diagnostic section time-series data acquired when machining is performed in a diagnostic section from a middle position to a machining end position of the hole from the time-series data acquired by the data acquisition unit; and
a deterioration diagnostic unit configured to diagnose deterioration of the drilling tool using the diagnostic section time-series data extracted by the diagnostic section extraction unit.

2. The tool diagnostic device according to claim 1, wherein the diagnostic section time-series data is difference time-series data indicating a difference between the time-series data acquired when machining is performed in the diagnostic section using a new drilling tool and the time-series data acquired when machining is performed in the diagnostic section using a non-new drilling tool.

3. The tool diagnostic device according to claim 1, wherein a length of the diagnostic section is a length equal to or greater than an initial section from an entrance to the middle position of the hole.

4. The tool diagnostic device according to claim 1, wherein the time-series data acquired by the data acquisition unit is at least one of data indicating torque of a spindle of a machine tool and data indicating a rotation speed of the spindle.

5. The tool diagnostic device according to claim 1, wherein the time-series data acquired by the data acquisition unit is at least one of command data for machining the hole and feedback data fed back when the hole is machined.

6. The tool diagnostic device according to claim 1, further comprising a feature extraction unit configured to extract feature data indicating a feature of the diagnostic section time-series data,
wherein the deterioration diagnostic unit diagnoses deterioration of the drilling tool based on the feature data extracted by the feature extraction unit.

7. The tool diagnostic device according to claim 6, further comprising a learning unit configured to learn a correlation between the feature data and a remaining lifespan of the drilling tool,
wherein the deterioration diagnostic unit diagnoses a remaining lifespan of the drilling tool based on a learning result in the learning unit.

8. The tool diagnostic device according to claim 6, wherein the feature data is data indicating at least one of an average, a variance, a degree of skew, and kurtosis of data values indicated by the diagnostic section time-series data.

9. The tool diagnostic device according to claim 1, further comprising a presentation unit configured to present a diagnosis result of the drilling tool diagnosed by the deterioration diagnostic unit.

10. The tool diagnostic device according to claim 1, wherein the data acquisition unit acquires the time-series data from a plurality of machine tools.

11. A tool diagnostic method comprising:
acquiring time-series data related to a deterioration state of a drilling tool when a hole is machined;
extracting diagnostic section time-series data acquired when machining is performed in a diagnostic section from a middle position to a machining end position of the hole from the time-series data; and
diagnosing deterioration of the drilling tool using the extracted diagnostic section time-series data.
